(19) United States
(12) Patent Application Publication
(10) Pub. No.: US 2018/0020654 A1
(43) Pub. Date: Jan. 25, 2018

(54) Microparticle Structure for Slow Release of Insect Attractant Pheromone

(71) Applicant: Chaoyang University of Technology, Taichung City (TW)

(72) Inventors: Mei-Ching Lin, Taichung City (TW); Wei-Jyun Chien, Taichung City (TW); Chi-Chang Yang, Taichung City (TW); Yu-Jhe Shen, Taichung City (TW); Wei-Ting Hsieh, Taichung City (TW)

(73) Assignee: Chaoyang University of Technology

(21) Appl. No.: 15/643,118

(22) Filed: Jul. 6, 2017

(30) Foreign Application Priority Data
Jul. 20, 2016 (TW) 105210938

(51) Int. Cl. A01M 1/02; C05F 11/00; C05G 3/00; C05F 11/08; A01N 25/28; A01N 61/00

(52) U.S. Cl. CPC A01M 1/023; A01N 25/28; A01N 61/00; C05G 3/00; C05G 3/0029; C05F 11/08; C05F 11/00

(57) ABSTRACT

A microparticle structure for a slow release of an insect attractant pheromone includes: a core layer and a shell layer. The core layer may include a carrier and a first attractant pheromone, wherein the carrier is formed of a biodegradable material. The shell layer may be a shell including a plurality of microcapsules encapsulating the core layer, wherein the plurality of microcapsules include a chitosan shell and a second attractant pheromone encapsulated by the chitosan shell.

### CROSS-REFERENCE TO RELATED APPLICATION

This application claims priority from Taiwan Patent Application No. 105210938, filed on Jul. 20, 2016 at the Taiwan Intellectual Property Office, the contents of which are hereby incorporated by reference in their entirety for all purposes.

### BACKGROUND OF THE INVENTION

### 1. Field of the Invention

The present invention relates to a structure for a slow-release of a substance, and in particular, relates to a microparticle structure for a slow release of an insect attractant pheromone.

### 2. Description of the Related Art

Research has shown that use of biological pheromones to lure and disrupt pests does not contribute to the development of drug resistance in pests, nor does it involve releasing pesticides into the environment and the pesticides coming into contact with fruit, vegetables and other crops. For the purpose of luring pests, most current pheromones traps are a plastic tube or a rubber cap, wherein the plastic tube has an expiration date of about 1 month, and the rubber cap has different expiration dates depending on which rubber material it is made of. However, it is difficult to control the concentrations released of such pheromone traps up to the expiration date. The traps might also cause environmental pollution if not properly disposed, because the carrier used therein is not biodegradable.

Biodegradable plastic is a natural resource such as a polymer that can be repeatedly produced by microbes, plants, and animals. Such plastic may be degraded by microbes to produce water, carbon dioxide, or methane in a natural buried or composting environment with sufficient moisture, oxygen and appropriate microbes; and their use causes less damage to the environment than traditional non-degradable plastic materials. However, the slow-release of an attractant pheromone using biodegradable plastic has yet to be devised.

Consequently, the present disclosure provides an inventive concept for a microparticle structure for a slow release of an insect attractant pheromone and thereby overcoming the limitations of the prior art and facilitating its implementation in industry.

### SUMMARY OF THE INVENTION

According to the problems mentioned above, the purpose of the present disclosure is to provide a microparticle structure for a slow release of an insect attractant pheromone, which achieves a slow-release effect via a double-layer structure.

For the purpose, the present disclosure provides a microparticle structure for a slow release of an insect attractant pheromone, including: a core layer and a shell layer. The core layer may include a carrier and a first attractant pheromone, wherein the carrier is formed of a biodegradable material. The shell layer may be a shell including a plurality of microcapsules for encapsulating the core layer, wherein the plurality of microcapsules include a chitosan shell and a second attractant pheromone encapsulated by the chitosan shell.

Preferably, the carrier is selected from at least one material of a group consisting of polylactide (PLA), polyhydroxybutyrate (PHB), water-degradable thermoplastic polyurethane (TPU), and poly(butylene succinate) (PBS).

Preferably, the carrier has a predetermined porosity.

Preferably, the core layer further includes a fertilizer which is encased within the carrier.

Preferably, the fertilizer includes an active microorganism or a metabolite thereof.

Preferably, the shell layer further includes a degrading enzyme capable of degrading the biodegradable material.

Preferably, the concentration of the first attractant pheromone is different from the concentration of the second attractant pheromone.

Preferably, the first attractant pheromone and the second attractant pheromone include a sex pheromone.

Accordingly, the microparticle structure for a slow release of an insect attractant pheromone of the present disclosure may have one or more of the following advantages:

(1) The microparticle structure for a slow release of an insect attractant pheromone of the present disclosure may be capable of a slow-release effect of long duration via its double-layer structure, wherein the pheromones are disposed in both layers.

(2) The microparticle structure for a slow release of an insect attractant pheromone of the present disclosure may replace currently used plastic tube pheromone traps so as to reduce environmental issues caused by using the plastic tubes.

Hereinafter, a detailed description of one or more preferred embodiments, which reference appended drawings, is disclosed. The preferred embodiments are described so that the above-mentioned purposes, technical features and practical implementation may be more apparent and easier to discern.

### BRIEF DESCRIPTION OF THE DRAWINGS

FIG. 1 is a schematic view illustrating the first structure of the microparticle structure for a slow release of an insect attractant pheromone of the present disclosure.

FIG. 2 is a schematic view illustrating the second structure of the microparticle structure for a slow release of an insect attractant pheromone of the present disclosure.

FIG. 3 is a first schematic view illustrating the microparticle structure for a slow release of an insect attractant pheromone of the present disclosure in use.

FIG. 4 is a second schematic view illustrating the microparticle structure for a slow release of an insect attractant pheromone of the present disclosure in use.

### DESCRIPTION OF THE PREFERRED EMBODIMENTS

Embodiments of the microparticle structure for a slow release of an insect attractant pheromone of the present disclosure will be described in the following with reference to the appended drawings. Same reference numerals refer to same elements throughout.

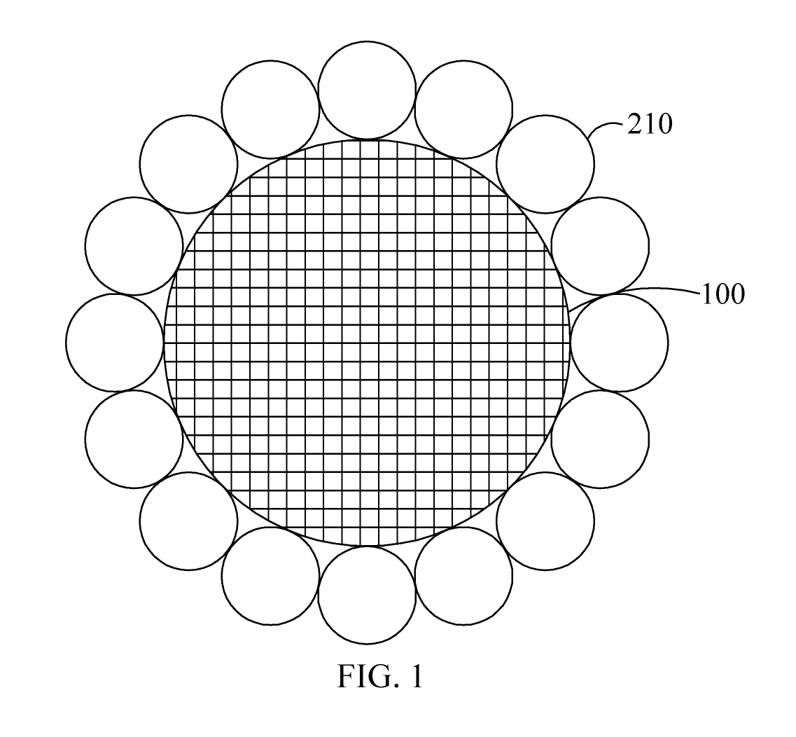

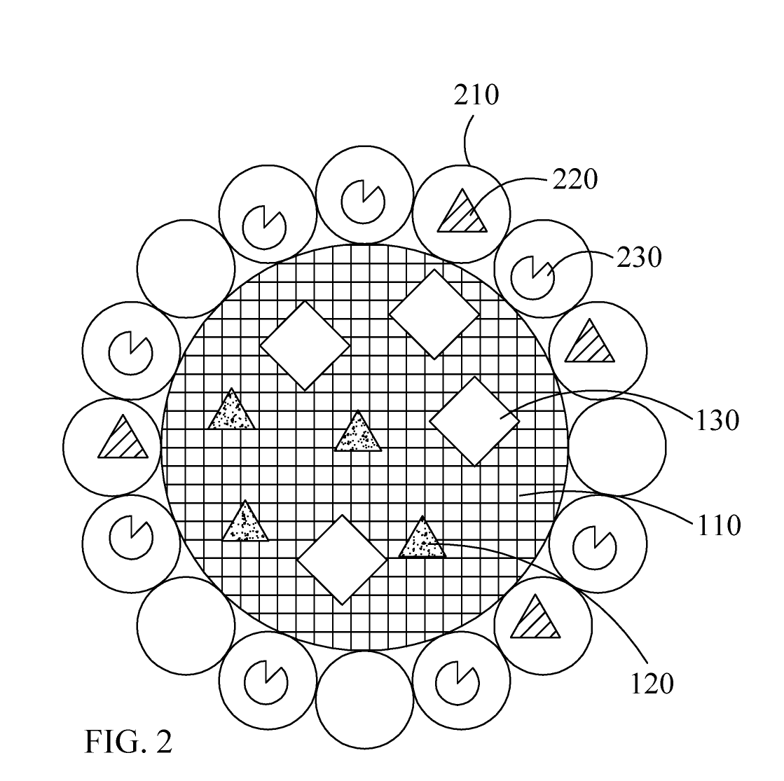

Please refer to FIG. 1 and FIG. 2, which are schematic views of the first and the second structures of the microparticle structure for a slow release of an insect attractant pheromone of the present disclosure, respectively. The microparticle structure for a slow release of an insect attractant pheromone of the present disclosure basically includes a double-layer structure formed by a core layer 100 and a shell layer 200.

The shell layer 200 may be a shell including a plurality of microcapsules, wherein the plurality of microcapsules encapsulates the core layer 100. The microcapsules may include a chitosan shell 210 and a second attractant pheromone 220 encapsulated by the chitosan shell 210. Hence, when the microcapsules come into contact with soil, the chitosan shell 210 may degrade due to acidic substances within the soil, and cause the second attractant pheromone 220 to be released first into the atmosphere, as a first phase of a release of the microparticle structure.

The core layer 100 may include a carrier 110 and the first attractant pheromone 120, wherein the carrier 110 may be formed of a biodegradable material and contains the first attractant pheromone 120 therewithin. When forming the carrier 110, the carrier 110 may be configured to have a predetermined porosity, so that the first attractant pheromone 120 fills pores of the carrier 110 when forming the core layer 100. Hence, when the shell layer 200 degrades, the first attractant pheromone 120 within the pores of the core layer 100 is released into the air when the pores become open to air, thereby achieving a second phase of the release of the microparticle structure.

The material of the carrier 110 may be at least one biodegradable material of a group consisting of polylactide (PLA), polyhydroxybutyrate (PHB), water-degradable thermoplastic polyurethane (TPU) and poly(butylene succinate) (PBS). Hence, when the first attractant pheromone 120 within the core layer 100 is completely released, the empty shell of the carrier 110 left in the soil may be degraded by microbes, which, when in a natural buried or composting environment with sufficient moisture, oxygen and appropriate microbes, will produce water, carbon dioxide or methane. Such a process reduces waste that may have to be disposed in a landfill or recycled, and may reduce damage to the environment.

The core layer 100 may further include a fertilizer 130, which is also encased within the carrier 110, and the fertilizer 130 may include a biological fertilizer, for instance, including active microorganisms such as bacteria (including actinomycetes), fungi, algae, dormant spores of microorganisms, their metabolites and other appropriate agents or ingredients. The fertilizer 130 may be released into the soil as the core layer 100 degrades, and thereby replenishing the soil with nutrients.

The shell 200 may further include a degrading enzyme 230 for degrading the carrier 110 formed of the biodegradable material so as to is control the rate of release of the first attractant pheromone 120 within the core layer 100. In addition, because of the microcapsules of the shell layer 200, the chitosan shell 210 may only be degraded when coming into contact with soil. Hence, the degrading enzyme 230 within the microcapsules that do not come into contact with soil may be retained for longer. Furthermore, when the first attractant pheromone 120 within the core layer 100 has been completely released, the degrading enzyme 230 may continue to quickly degrade the empty carrier 110 of the core layer 100 and therefore is more environmentally friendly as it significantly reduces the time taken to degrade the carrier completely away.

Furthermore, the first attractant pheromone 120 and the second attractant pheromone 220 contained within the core layer 100 and the shell layer 200 respectively may be released at different times depending on the configuration thereof. Hence, the microparticle structure may be configured such that the first attractant pheromone 120 and the second attractant pheromone 220 are present in different effective concentrations, with low concentrations luring a target insect and high concentrations disrupting the life routine of the target insect taking effect at different release times, thereby allowing for a phased, step-by-step mechanism for the release of pheromones for pest control. The concentrations of the first attractant pheromone 120 and the second attractant pheromone 220 may also be adjusted depending on the release rate of the attractant pheromones from the carrier, so as to maintain a similar concentration of the released attractant pheromones over the duration of release.

The first attractant pheromone 120 and the second attractant pheromone 220 may include one or more sex pheromones, wherein the one or more sex pheromones may include, for instance, esters, alcohols, aldehydes, acids, ring or chain structures thereof, or a combination of any compounds mentioned above, for the required effect in pest control.

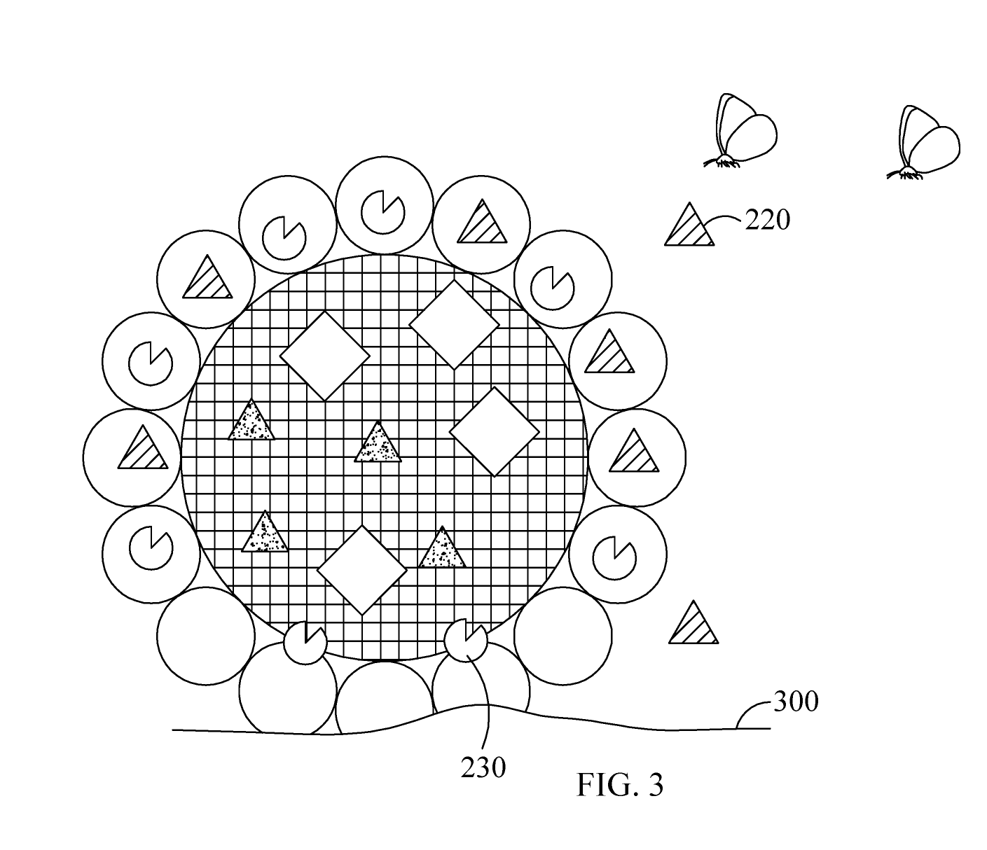

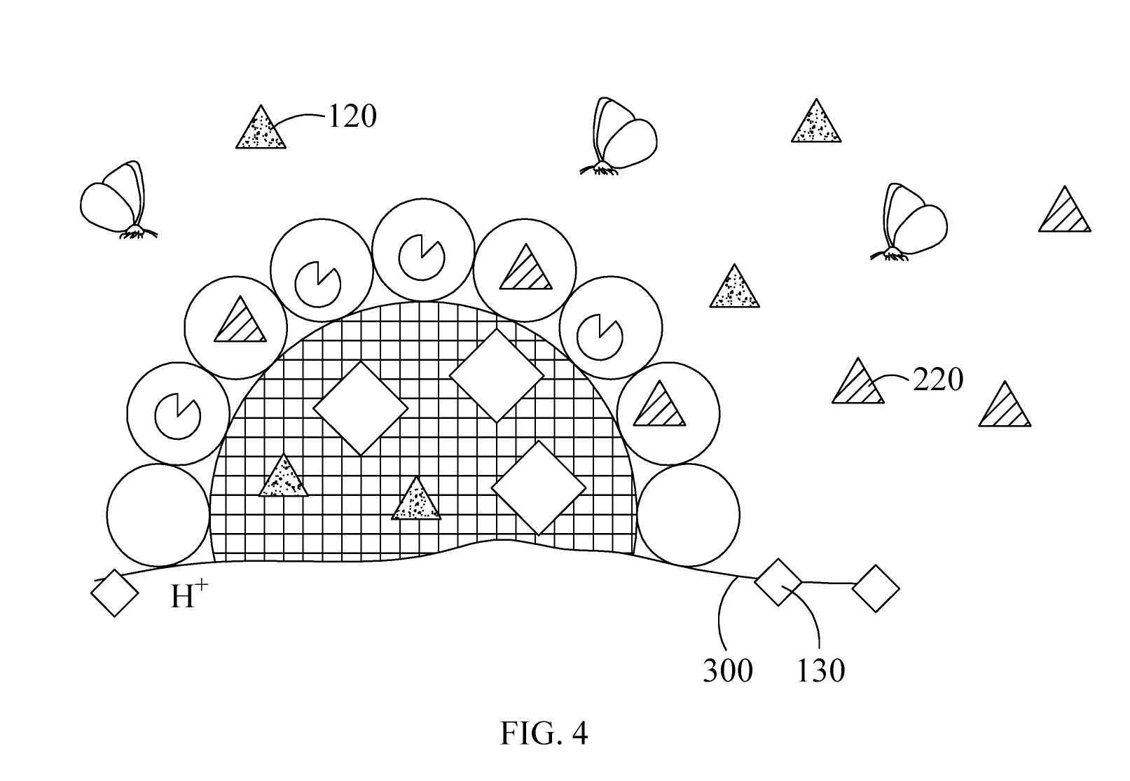

Please refer to FIGS. 2, 3 and 4. FIGS. 3 and 4 are first and the second schematic views, respectively, showing the microparticle structure for a slow release of an insect attractant pheromone of the present disclosure in use.

Due to the acidic nature of Taiwan's soil, when a pest control preparation containing the microparticle structure for a slow release of an insect attractant pheromone of the present disclosure is applied to the soil 300, the chitosan shell 210 degrades on contact with the soil 300, thereby releasing the second attractant pheromone 220 into the air and also releasing the degrading enzyme 230, thereby achieving the first phase. Then, the released degrading enzyme 230 gradually degrades the carrier 110, releasing the first attractant pheromone 120 in the second phase. Concurrently, the fertilizer 130 within the core layer (not shown) is also gradually released, replenishing the soil with nutrients.

The microparticle structure for a slow release of an insect attractant pheromone of the present disclosure is not only capable of a slow-release effect, but is also able to replace the type of currently used pheromone traps such as plastic tube forms, thereby reducing the effect on the environment that such plastic tubes have. Additionally, since the chitosan shell and the biodegradable material used can both degrade in the environment, their use reduces waste that would otherwise accumulate in the soil, and so further reducing damaging effects on the environment.

It is to be understood that the present invention is not limited to the contents described above. Any modifications and alterations which do not depart from the spirit and scope of the present disclosure are intended to be included within the scope of the appended claims.

What is claimed is:

1. A microparticle structure for a slow release of an insect attractant pheromone, comprising:
a core layer comprising a carrier and a first attractant pheromone encased by the carrier, wherein the carrier is formed of a biodegradable material; and
a shell layer comprising a plurality of microcapsules, wherein the plurality of microcapsules encapsulates the core layer, and the microcapsules comprises a chitosan shell and a second attractant pheromone encapsulated by the chitosan shell.

2. The microparticle structure of claim 1, wherein the carrier is selected from at least one material of a group consisting of polylactide (PLA), polyhydroxybutyrate (PHB), water-degradable thermoplastic polyurethane (TPU), and poly(butylene succinate) (PBS).

3. The microparticle structure of claim 1, wherein the carrier has a predetermined porosity.

4. The microparticle structure of claim 1, wherein the core layer further comprises a fertilizer, which is encased by the carrier.

5. The microparticle structure of claim 4, wherein the fertilizer comprises at least one active microorganism and/or at least one metabolite thereof.

6. The microparticle structure of claim 1, wherein the shell layer further comprises a degrading enzyme capable of degrading the biodegradable material.

7. The microparticle structure of claim 1, wherein the concentration of the first attractant pheromone is different from the concentration of the second attractant pheromone.

8. The microparticle structure of claim 1, wherein the first attractant pheromone and the second attractant pheromone comprise at least one sex pheromone.
